(19) United States
(12) Patent Application Publication
(10) Pub. No.: US 2019/0034901 A1
(43) Pub. Date: Jan. 31, 2019

(54) SELF SERVICE TERMINAL ENABLING AUTO-PRESSING OF KEYS AND METHOD THEREOF

(71) Applicant: Convipay Inc., Dover, DE (US)

(72) Inventors: Anshoo Gaur, Naperville, IL (US); Aroon Ashish Khatter, Dover, DE (US)

(21) Appl. No.: 15/662,343

(22) Filed: Jul. 28, 2017

(51) Int. Cl. G06Q 20/20; G06Q 10/08; G06K 7/14; G06K 19/06

(52) U.S. Cl. CPC G06Q 20/206; G06K 19/06037; G06K 7/1417; G06Q 10/087

(57) ABSTRACT

A self-service terminal enabling auto-pressing one or more keys of the self-service for triggering one or more tasks associated with delivery of one or more services through the self-service terminal and related system and method thereof is disclosed herein. The self-service terminal may comprise a processor unit and a memory unit. The self-service terminal may auto-pair with a user device within a predefined distance from the self-service terminal. The processor unit may receive information from the user device in response to the auto-pairing of the user device with the self-service terminal. The processor unit may decode the information to retrieve data associated to one or more tasks corresponding to delivery of one or more services through the self-service terminal. The processor unit may enable auto-pressing of one or more keys of the keypad based upon the data retrieved in order to trigger the delivery of the one or more services.

### CROSS-REFERENCE TO RELATED APPLICATIONS AND PRIORITY

The present application does not claim priority from any other patent application(s).

### TECHNICAL FIELD

The present invention in general relates to a self-service terminal that enabling auto-pressing of keys and method thereof.

### BACKGROUND

The self-service terminals provide optimal customer services to the customer. These terminals offer cash or cashless payment functionality. The self-service terminal such as vending device dispenses service/product to the user when user enters transaction details such as PIN or authorization code or any other inputs for cash or cashless transactions through the user interface of the self-service terminal. Further, the user performs selection of service by manually entering details in to self-service terminal. The self-service terminals provide optimal customer services through payment at transaction terminals. These self-service terminals offer cash or cashless payment functionality for services like payment of various fees, payment of bills, transfer of money, payment of tickets, top up prepaid cards, and payment for goods or services. While performing cashless transaction, the user/customer needs to enter PIN or authorization code to the self-service terminal manually. Sometimes, the user enters wrong code into the self-service terminal due to human error which results in the denial of the service from the self-service terminal. This results into wastage of time and efforts of the user/customer.

### SUMMARY

Before the present device, system and their method of use are described, it is to be understood that this disclosure is not limited to the particular device/system and its arrangement as described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is not intended to identify essential features of the subject matter nor it is intended for use in detecting or limiting the scope of the proposed subject matter.

In one implementation, a self-service terminal enabling auto-pressing one or more keys of the self-service for triggering one or more tasks associated with delivery of one or more services through the self-service terminal is disclosed. In one aspect, the self-service terminal may comprise a processor unit and a memory unit coupled with the processor unit. The processor unit may be configured to execute programmed instructions stored in the memory unit. Specifically, the processor unit may execute a programmed instruction for enabling auto-pairing of the processor unit with the user device. The processor unit may execute a programmed instruction for receiving information from the user device in response to auto-pairing of the user device with the self-service terminal. The processor unit may further execute a programmed instruction for decoding the information to retrieve data associated to one or more tasks corresponding to delivery of one or more services through the self-service terminal. Further, the processor unit may execute a programmed instruction for enabling auto-pressing of one or more keys of the keypad based upon the data retrieved in order to trigger delivery of one or more services through the self-service terminal.

In another implementation, a system for enabling auto-pressing of keys of self-service terminal is disclosed. The system may comprise a processor and a memory coupled with the processor. The processor may be configured to execute programmed instructions stored in the memory. In one aspect, the processor may execute a programmed instruction for enabling auto-pairing of the processor unit with the user device. In one aspect, the processor may execute a programmed instruction for enabling auto-pairing of the user device associated with the self-service terminal. The processor may further execute a programmed instruction for transmitting information to a processor unit of the self-service terminal, wherein the processor unit is further configured to decode information to retrieve data associated to one or more tasks corresponding to delivery of one or more services through the self-service terminal. In one aspect, the decoding enables auto-pressing of one or more keys of the keypad based upon the data retrieved in order to trigger the delivery of the one or more services.

In another implementation, a method for enabling auto-pressing of keys of self-service terminal is disclosed. The method may comprise enabling, via the processor, auto-pairing of the user device with the self-service terminal. The method may further comprise transmitting, via the processor, information to a processor unit of the self-service terminal wherein the processor unit is further configured to decode the information to retrieve data associated to one or more tasks corresponding to delivery of one or more services through the self-service terminal. In one aspect, the decoding enables auto-pressing of one or more keys of the keypad based upon the data retrieved in order to trigger the delivery of the one or more services.

### BRIEF DESCRIPTION OF DRAWINGS

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates an implementation 100 of a system 101 for enabling auto-pressing of one or more keys of a self-service terminal, in accordance with an embodiment of the present subject matter.

FIG. 2 illustrates a block diagram 200 depicting components of the self-service terminal, in accordance with an embodiment of the present subject matter.

FIG. 3 illustrates the system 101 and components of the system 101, in accordance with the embodiment of the present subject matter.

FIG. 4 illustrates an example of the self-service terminal in form of a vending device, in accordance with the embodiment of the present subject matter.

FIG. 5 illustrates an example dispensing of the product(s) from the vending device via the processing unit, in accordance with the embodiment of the present subject matter.

FIG. 6 illustrates an example of the self-service terminal in form of an Automated Teller Machine (ATM), in accordance with the embodiment of the present subject matter.

FIG. 7 illustrates an example of the self-service terminal in form of an interactive Kiosk, in accordance with the embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

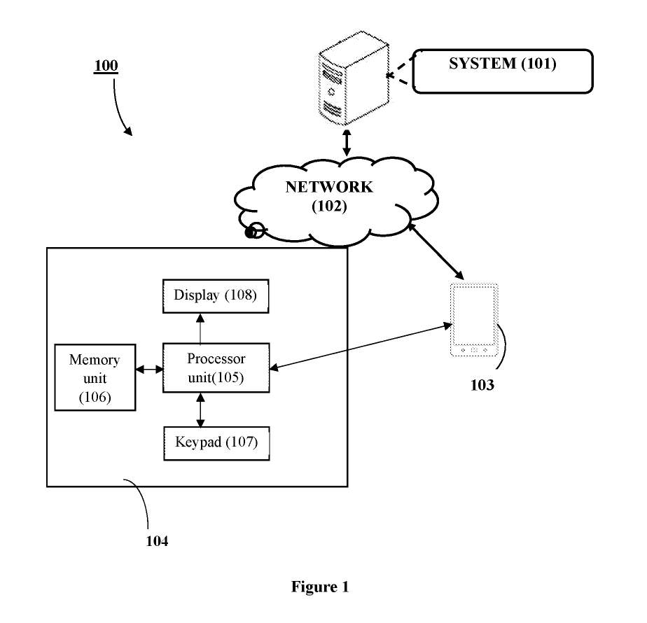

Referring to FIG. 1, a network implementation 100 of a system 101 for enabling auto-pressing of keys of self-service terminal, in accordance with an embodiment of the present subject matter. As shown in FIG. 1, a self-service terminal 104 may comprise a processor unit 105, a memory unit 106, a keypad 107 and a display 108. The processor unit 105 may be communicatively coupled with a user device 103. In one embodiment, the processor unit 105 may communicate with the user device 103 through a short-range wireless communication protocol selected from a group comprising, but not limited to, Bluetooth communication protocol, Near Field Communication (NFC), Radio Frequency (RF) protocol, an infra-red (IR) protocol, ZigBee protocol and the like. In another embodiment, the processor unit 105 may communicate with the user device 103 through a router within the self-service terminal 104. Further, the user device 103 may be communicatively coupled with the system 101.

Although the present subject matter is explained considering that the system 101 is implemented as on a server, it may be understood that the system 101 may also be implemented in a variety of computing systems, such as a laptop computer, a desktop computer, a notebook, a workstation, a mainframe computer, a server, a network server, and the like. It will be understood that the system 101 may be accessed by multiple users through one or more user devices 103-1, 103-2 . . . 103-N, collectively referred to as user 103 hereinafter, or applications residing on the user devices 103. Examples of the user devices 103 may include, but are not limited to, a portable computer, a personal digital assistant, a handheld device, and a workstation. The user devices 103 are communicatively coupled to the system 101 through a network 102.

In one implementation, the network 102 may be a wireless network, a wired network or a combination thereof. The network 102 can be accessed by the user device 104 using wired or wireless network connectivity means including updated communications technology. The network 102 can be implemented as one of the different types of networks, such as intranet, local area network (LAN), wide area network (WAN), the internet, and the like. The network 102 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 102 may include a variety of network devices, including routers, bridges, servers, computing devices, storage devices, and the like.

In one embodiment, the system 101 may be configured to perform auto-pairing of the user device with the self-service terminal. In one embodiment, the user device 103 may perform auto-pairing of the user device 103 with the self-service terminal 104 by scanning of the QR code or barcode displayed on the self-service terminal 104. In one embodiment, the user device 103 may be configured to scan a QR code or a barcode. The QR code may be either printed on the self-service terminal or embedded as an image within the display of the self-service terminal. In another embodiment, the user device 103 may perform auto-pairing with the self-service terminal 104 with the user device 103 by auto-polling of the self-service terminals in the predefined range of the user device. Specifically, the user device 103 may initiate auto-polling of the self-service terminal within the predefined range of the user device and thereby display the list of self-service terminals on a display screen of the user device 103 identified as a result of the auto-polling technique. The user may select a self-service terminal from the list of self-service terminals displayed for enabling the auto-pairing of the user device 103 with the self-service terminal selected. In yet another embodiment, the user device 103 may perform auto-pairing with the self-service terminal using one or more of tactile inputs, gesture inputs, and voice commands received from the user either via the user device or the self-service terminal or both. In still another embodiment, the user device 103 may perform auto-pairing with the vending device having geospatial data (latitude or longitude or both) closely matching with the geospatial data of the user device 103. In one embodiment, the processor unit 105 may receive the information from the user device 103. In one embodiment, the information may at least comprise code. In one embodiment, the code may be unique alphanumeric code. In one embodiment, the processor unit 105 may be configured to decode the information to retrieve data. The decoded information may be related to one or more tasks associated with delivery of one or more services through the self-service terminal 104.

In one embodiment, the processor unit 105 may be coupled with ports of the keypad 107 and the display 108. The processor unit 105 may be configured to enable auto-pressing one or more keys of the keypad after receiving the information from the user device 103. In one embodiment, the auto-pressing of the one or more keys of the keypad 107 may enable triggering of one or more tasks associated with delivery of one or more services through the self-service terminal 104.

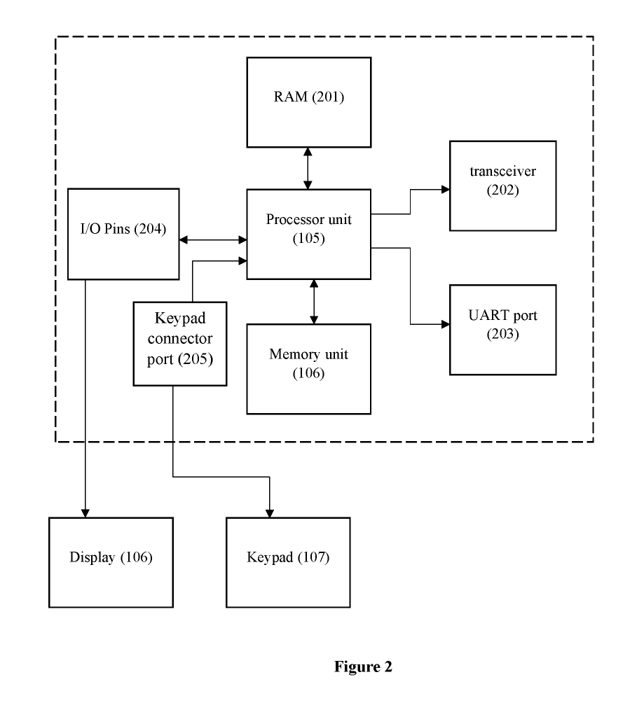

Referring to FIG. 2, a block diagram 200 depicting components of the self-service terminal is illustrated, in accordance with an embodiment of the present subject matter. In one embodiment, the self-service terminal comprises associated electronic circuitry with the processor unit 105 and the memory unit 106. In one embodiment, associated electronic circuitry comprises a Random-Access Memory (RAM) 201, a transceiver 202, I/O pins 204, a keypad connector port 205, a UART port 203. In one embodiment, the processor unit 105 may be electronically coupled with the memory unit 106, the RAM 201, the transceiver 202, the I/O pins 204, keypad connector port 205 and the UART port 203. In one embodiment, the display 108 may be electronically coupled with the processor via the I/O pins 204. In one embodiment, the keypad 107 may be electronically coupled with the processor 201 through the keypad connector port 207. In one embodiment, the processor unit 105 may be retrofitted with self-service terminal through the communication port/interface. In one exemplary embodiment, the communication port/interface is UART port 203. In one embodiment, the processor unit 105 may be retrofitted with the self-service terminal 104 in order to trigger one or more tasks associated with delivery of one or more services through the self-service terminal 104. In one embodiment, the transceiver 202 may be configured to facilitate communication between the processor unit 105 and the user device 103. In one embodiment, the transceiver may be configured to facilitate the communication between the processor unit 105 and the user device 103 located within a predefined distance of the self-service terminal 104. In one embodiment, the transceiver 202 may be configured to communicate with the user device 103 using a short-range communication protocol.

In one embodiment, the memory unit 106 is coupled with the processor unit 105. The processor unit 105 is configured to execute programmed instructions stored in the memory unit 106. In one embodiment, the processor unit 105 is configured to execute programmed instructions in order to establish communication between the processor unit 105 with the user device 103 located within a predefined distance from the self-service terminal 104. Further, the processor 105 unit may execute instructions for receiving information from the user device 103. In one embodiment, the processor unit 105 may receive the information from the user device 103 in response to auto-pairing of the user device with the self-service terminal. In one embodiment, the processor unit 105 may execute programmed instructions for decoding information in order to retrieve data associated to one or more tasks associated with delivery of one or more services through the self-service terminal. The processor unit 105 may further execute instructions for enabling auto-pressing of one or more keys of the keypad based upon the data retrieved in order to trigger the delivery of the one or more services.

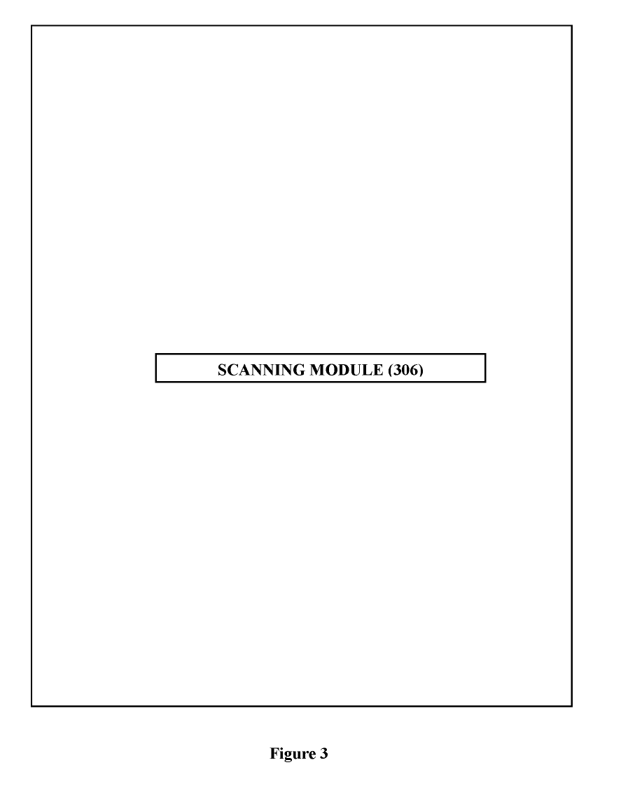

Now referring to FIG. 3, components of the system 101 are illustrated, in accordance with an embodiment of the present subject matter. The system 101 may comprise at least one processor 301, an input/output (I/O) interface 302, a memory 303, modules 304 and data 309. In one embodiment, the at least one processor 301 may be configured to fetch and execute computer-readable instructions stored in the memory 303.

In one embodiment, the I/O interface 302 may include a variety of software and hardware interfaces, for example, a web interface, a graphical user interface, and the like. The I/O interface 302 may allow the system 101 to interact with the user devices 103. Further, the I/O interface 302 may enable the user device 103 to communicate with other computing devices, such as web servers and external data servers (not shown). The I/O interface 302 can facilitate multiple communications within a wide variety of networks and protocol types, including wired networks, for example, LAN, cable, etc., and wireless networks, such as WLAN, cellular, or satellite. The I/O interface 302 may include one or more ports for connecting to another server.

In an implementation, the memory 303 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and memory cards. The memory 303 may include modules 304 and data 309.

The modules include routines, programs, objects, components, data structures, etc., which perform particular tasks, functions or implement particular abstract data types. In one implementation, the modules may an identification module 305, a scanning module 306, a code generation module 307, a transmission module 308 and other modules (not shown in figure). The other modules may include programs or coded instructions that supplement applications and functions of the user device.

In one embodiment, the data 309 may comprise repository 310 and other data 311. In one exemplary embodiment, the repository 310 may be configured to store data processed, received, and generated by one or more of the modules 304. In one exemplary embodiment, the repository 310 may store database of the vending devices such as vending device ID and corresponding MAC address. The other data 311 may include data generated as a result of the execution of one or more modules.

In one implementation, a user may use the user device 103 to register with the system 101 via I/O interface 302. The user may use an application installed over the user device 103 in order to register with the system 101.

In one embodiment, the identification module 306 may be configured to identify the self-service terminal within a predefined distance from the user device 103. In one embodiment, the location of user device 103 may be captured via GPS module within the user device 103. In one embodiment, the processor 301 may comprise a programmed instruction to enable the user to scan a QR code displayed on the self-service terminal 104. In one embodiment, the scanning module 306 may enable scanning of the QR code displayed on the self-service terminal using an image capturing means (Not shown in the FIG. 3) of the user device. In one embodiment, the QR code or the barcode may comprise identification details of the self-service terminal 104 in order to perform verification. In one exemplary embodiment, the self-service terminal may be marked with specific number identification system. Further, the number may be stored in the QR code or the barcode. In one embodiment, the system 101 implemented on the user device 103 may enable user to communicate with the self-service terminal 104. In one embodiment, the user device 103 may communicate with the self-service terminal 104 by auto pairing with the processor unit 105. In one embodiment, the user device 103 may be paired with the processor unit 105 through the wireless communication protocol selected from a group comprising, but not limited to, Bluetooth communication protocol, Near Field Communication (NFC), Radio Frequency (RF) protocol, an infra-red (IR) protocol, ZigBee protocol and the like. In another embodiment, the user device 103 may be paired with the processor unit 105 through a router (Not shown in the figure) wherein the router is placed within self-service terminal. The router may provide connectivity with one or more user devices without any internet connection. In another embodiment, the user device 103 may perform auto-pairing of the vending device with the user device by auto-polling of the vending devices in the predefined range of the user device. Specifically, the user device 103 may initiate auto-polling of the vending devices within the predefined range of the user device and thereby display the list of vending devices on a display screen of the user device 103 identified as a result of the auto-polling technique. The user may select a vending device from the list of vending devices displayed for enabling the auto-pairing of the user device 103 with the vending device selected. In yet another embodiment, the user device 103 may perform auto-pairing with the vending device using one or more of tactile inputs, gesture inputs, and voice commands received from the user either via the user device or the vending device or both. In still another embodiment, the user device 103 may perform auto-pairing with the vending device having geospatial data (latitude or longitude or both) closely matching with the geospatial data of the user device 103.

In one embodiment, the code generation module 307 may be configured to generate the unique alphanumeric code. In one embodiment, the unique alphanumeric code may be generated in response to the auto-pairing of the user device with self-service terminal. In one exemplary embodiment, when the user approaches to the self-service terminal, the user device 103 may enable the user to scan the QR code or the barcode displayed on the self-service terminal 104. The user device 103 may identify the self-service terminal. The code generation module 306 may generate the unique alphanumeric code which may comprise identification information of self-service terminal as well as information of one or more tasks associated with delivery of one or more services through the self-service terminal 104. In one embodiment, the unique alphanumeric code comprises characters that identifies location of the self-service terminal.

In one embodiment, the transmission module 308 may be configured to transmit the information to a processor unit 105 of the self-service terminal 104. The information may be transmitted to the processor unit 105 through the user device 103. In one embodiment, the processor unit 105 may decode the information to retrieve data associated to one or more tasks associated with delivery of one or more services through the self-service terminal 104. Further, the processor unit 105 may enable auto-pressing of one or more keys of the keypad based upon the data retrieved in order to trigger the delivery of the one or more services from the self-service terminal 104.

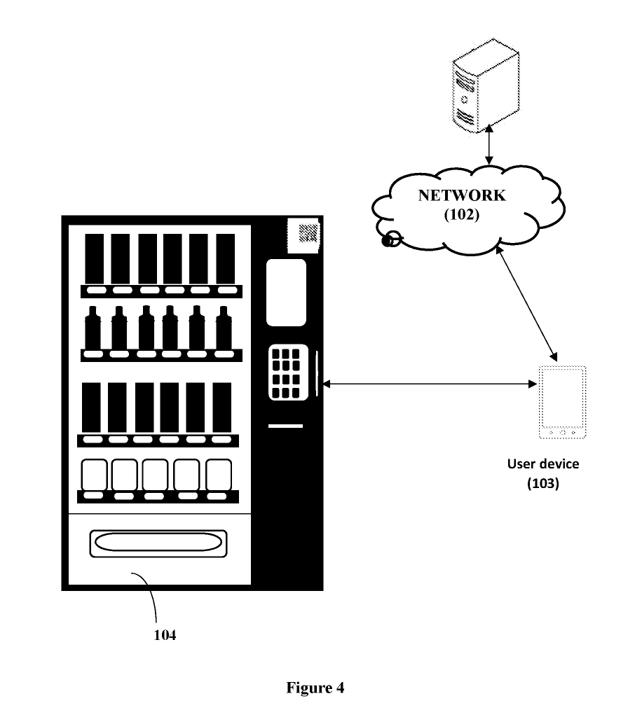

Now referring to FIG. 4, an exemplary embodiment of the present subject matter is illustrated. In this embodiment, the self-service terminal 104 may be a vending device. The processor unit 105 may be retrofitted with the vending device. The processor unit 105 may receive information after auto-pairing of the user device with the vending device. In one embodiment, the user device 103 may perform auto-pairing of the user device 103 with the vending device by scanning of the QR code or barcode displayed on the vending device. In one embodiment, the user device 103 may be configured to scan a QR code or a barcode. The QR code may be either printed on the vending device or embedded as an image within the display of the vending device. The processor unit 105 may decode the information to retrieve the data of the task assigned by the user. Further, the processor unit 105 may perform predefined mapping of the information of the task assigned by the user. In one case scenario, if user wants to dispense ‘coke can’ from the vending device marked with number A02. The user may scan the QR code displayed on the vending device A02 using user device. The user selects the coke can which is being vend through the vending device using user device. The user may select the ‘coke can’ from the list displayed on the user device and perform associated electronic transaction before or after scanning of the QR code. The user device may receive the information which comprises vending device number A02 and coke can product details such as price, quantity and location of the ‘coke can’ within the shelf of the vending device etc. The information may be received by the processor unit 105. The processor unit 105 may perform decoding and retrieve data of the coke can i.e. product details such as price, quantity and location of the ‘coke can’ within the shelf of the vending device etc. stored in the information. The memory unit 106 may store commands for dispensing the products. The processor unit 105 may perform predefined mapping of ‘coke can’ details with the commands stored in the memory unit of the processor unit 105. The processor unit 105 may auto-press the keys of the keypad along with the dispensing commands for instructing a dispensing motor to dispense the ‘coke can’ to the user.

In one embodiment, the keys of the keypad of the vending device may be frozen by the processor unit 105 at the time of receiving transaction from the user for dispensing product. In one embodiment, the transaction may be cash or cashless transaction. The processor unit 105 may release the keys of the keypad after receiving the transaction. In case of a cash transaction, the processor unit 105 may enable the user to enter the code manually on the keypad which triggers dispensing of a product/service via MDB protocol. In case of cashless transactions facilitated through the user device 103, the processor unit 105 may receive the information from the user device 103. In one embodiment, the processor unit 105 may be configured to decode the information in order to enable auto-pressing of one or more keys of the keypad based upon the data retrieved from the information thereby triggering the dispense of the product to the user without utilizing the MDB protocol.

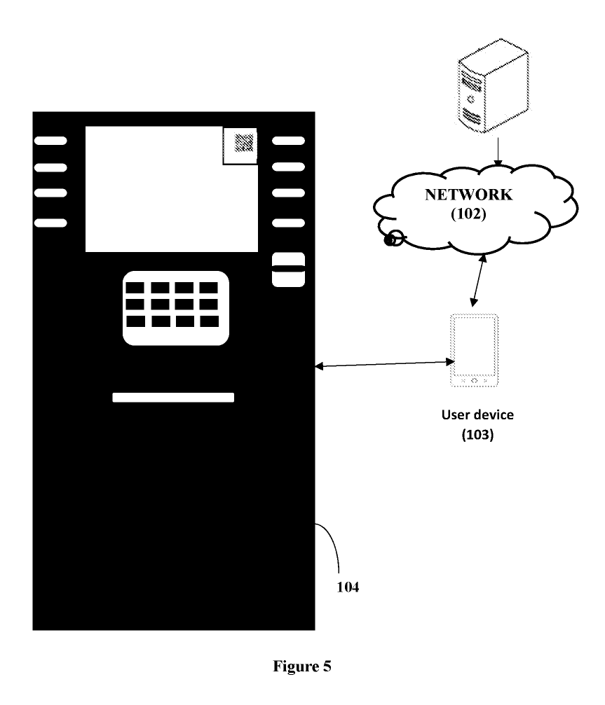

Now referring to FIG. 5, another exemplary embodiment of the present subject matter is illustrated. In this embodiment, the self-service terminal 104 may be an Automated Teller Machine (ATM). The processor unit 105 may be retrofitted with ATM. The system may enable customer to dispense cash from the ATM using the user device 103. The user may select the options which facilitates the banking functions through the user device 103. In one embodiment, the user may select option of cash withdrawal displayed on the user interface of the user device 103. Further, the user may enter transaction details stored in the user device 103, wherein the transaction details stored may include debit card details, credit card details, bank details along with Personal Identification Number (PIN) and amount. The system may be configured to verify the authorized user using PIN. The processor unit 105 may receive information after auto-pairing of the user device with ATM. In one embodiment, the user device 103 may perform auto-pairing of the user device 103 with the ATM by scanning of the QR code or barcode displayed on the ATM. In one embodiment, the user device 103 may be configured to scan a QR code or a barcode. The QR code may be either printed on the ATM or embedded as an image within the display of the ATM. The processor unit 105 may be configured to receive the information from the user device 103 as a response of auto-pairing. Further, the processor unit 105 may be configured to decode the information. The processor unit 105 may enable auto-pressing of one or more keys of the keypad based upon the information retrieved thereby triggering the dispense of cash to the user. In one embodiment, the processor unit 105 may auto-press one or more keys of the keypad to enter amount to be dispensed from the ATM. In one embodiment, the system 101 may enable user to transfer amount to the others account. The user may select option of money transfer available on the user device. The user may enter PIN, payee information and amount to be transferred to payee. The system may verify the authorized user using PIN. The user device may enable user to scan the QR code or barcode displayed on the ATM. After scanning of the QR code, the system may enable user device to receive information. In one embodiment, the information may comprise unique alphanumeric code. In one embodiment, information may comprise amount to be transferred from the ATM and authentication data. The processor unit 105 may perform decoding and retrieve the details of the account details for transfer. The processor unit 105 may perform predefined mapping of the account details for transfer with the commands stored in the memory unit 106. The processor unit 105 may auto-press the keys of the keypad to transfer amount to other account along with transfer commands.

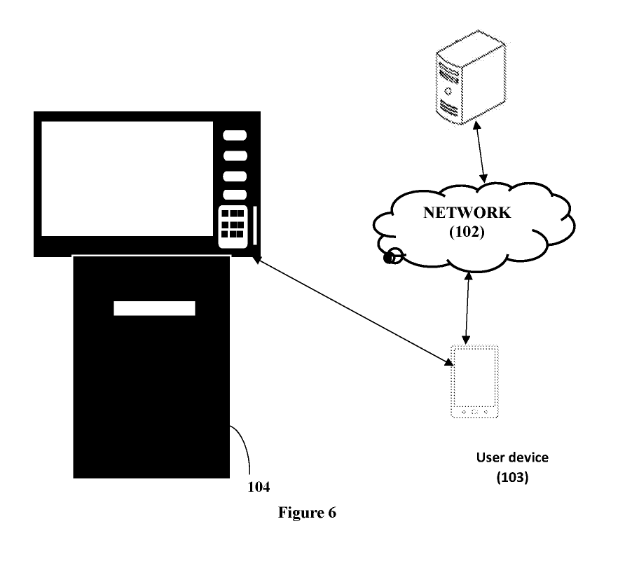

Now referring to FIG. 6, yet another exemplary embodiment of the present subject matter is illustrated. In this embodiment, the self-service terminal 104 may be an interactive Kiosk. The processor unit 105 may be retrofitted with the interactive Kiosk. The processor unit 105 may configured to deliver specific service to the user. The processor unit 105 may receive information from the user device 103 after auto-pairing with kiosk machine. The information may comprise transaction details associated with the service. The processor unit 105 may decode the information and further enables auto-pressing of one or more keys of the keypad based upon the data retrieved in order to trigger delivery of the service to the user. In one exemplary embodiment, the railway ticket kiosk may deliver tickets to the user after receiving information from the user device 103.

Although implementations for self-service terminal enabling auto-pressing of keys and method thereof have been described in language specific to structural features and/or methods, it is to be understood that the appended claims are not necessarily limited to the specific features or methods described. Rather, the specific features and methods are disclosed as examples of implementations for providing a self-service terminal enabling auto-pressing of keys and method thereof.

What is claimed is:

1. A self-service terminal enabling auto-pressing one or more keys of the self-service for triggering one or more tasks associated with delivery of one or more services through the self-service terminal, the self-service terminal comprising:
a processor unit; and
a memory unit coupled with the processor unit, wherein the processor unit is configured to execute programmed instructions stored in the memory for
enabling auto-pairing of the processor unit with the user device;
receiving information from the user device in response to auto-pairing of the user device with the self-service terminal;
decoding the information to retrieve data associated to one or more tasks associated with delivery of one or more services through the self-service terminal; and
enabling auto-pressing of one or more keys of the keypad based upon the data retrieved in order to trigger the delivery of the one or more services.

2. The self-service terminal of claim 1, wherein the processor unit is retrofitted with the self-service terminal.

3. The self-service terminal of claim 2, wherein the processor unit further comprises a communication port enabling electronic coupling of the keypad with the processor unit.

4. The self-service terminal of claim 2, wherein the processor unit further comprises a transceiver enabling communication of the processor unit with the user device located within a predefined distance from the self-service terminal.

5. The self-service terminal of claim 1, wherein the information is a unique alphanumeric code.

6. The self-service terminal of claim 1, wherein the auto-pairing is performed based upon scanning of a QR code displayed on the vending device, or auto-polling of vending devices, or tactile inputs received from the user, or voice commands received from the user, or gesture inputs received from the user, or geo-spatial data associated with the user device and the vending devices.

7. The self-service terminal of claim 1, wherein the memory unit stores a predefined mapping of the one or more keys and the one or more tasks associated with the delivery of the one or more services.

8. A system for enabling auto-pressing of keys of self-service terminal, the system comprising:
a processor; and
a memory coupled with the processor, wherein the processor is configured to execute programmed instructions stored in the memory for
enabling auto-pairing of the user device with the self-service terminal; and
transmitting information to a processor unit of the self-service terminal based upon the auto-pairing of the user device with the self-service terminal, wherein the processor unit is further configured to decode the information to retrieve data associated to one or more tasks associated with delivery of one or more services through the self-service terminal, and wherein the decoding enables the processor unit to auto-press one or more keys of the keypad based upon the data retrieved in order to trigger the delivery of the one or more services.

9. The system of the claim 8, wherein the information is a unique alphanumeric code.

10. The system of the claim 8, wherein auto-pairing is performed based upon scanning of a QR code displayed on the vending device, or auto-polling of vending devices, or tactile inputs received from the user, or voice commands received from the user, or gesture inputs received from the user, or geo-spatial data associated with the user device and the vending devices.

11. The system of claim 8, wherein the user device and the processor of the self-service terminal are communicatively coupled with each other through a wireless communication protocol selected from a group comprising, Bluetooth communication protocol, Near Field Communication (NFC), Radio Frequency (RF) protocol, an infra-red (IR) protocol, and ZigBee protocol.

12. A method for enabling auto-pressing of keys of self-service terminal, the method comprising
enabling, via a processor, auto-pairing of the user device with the self-service terminal; and
transmitting, via the processor, information to a processor unit of the self-service terminal based upon the auto-pairing of the user device with the self-service terminal, wherein the processor unit is further configured to decode the information to retrieve data associated to one or more tasks associated with delivery of one or more services through the self-service terminal, and wherein the decoding enables the processor unit to auto-press one or more keys of the keypad based upon the data retrieved in order to trigger the delivery of the one or more services.
